(19) United States
(12) Patent Application Publication
(10) Pub. No.: US 2020/0106693 A1
(43) Pub. Date: Apr. 2, 2020

(54) STATEFUL VIRTUAL STACK FORWARDING

(71) Applicant: HEWLETT PACKARD ENTERPRISE DEVELOPMENT LP, Houston, TX (US)

(72) Inventors: Ankit Kumar Sinha, Bangalore (IN); Ramlakhan Patel, Bangalore (IN); Venkatavaradhan Devarajan, Bangalore (IN)

(21) Appl. No.: 16/537,879

(22) Filed: Aug. 12, 2019

(30) Foreign Application Priority Data
Sep. 27, 2018 (IN) 201841036592

(51) Int. Cl. H04L 12/751; H04L 12/753; H04L 12/24

(52) U.S. Cl. CPC H04L 45/02; H04L 41/06; H04L 45/48

(57) ABSTRACT

Examples disclosed herein relate to a method comprising changing a state at a first device in a virtual stack forwarding (VSF) stack topology, wherein each device in the VSF stack topology has a synchronized state in a corresponding local database storing state and configuration for the device. The method may also comprise transmitting, from the first device, the changed state to a commander node of the VSF stack topology, committing, by the commander node, the changed state to a first local database of the commander node and transmitting, by the commander node, the changed state to a root node of the VSF stack topology. The method may also comprise committing, by the root node, the changed state to a second local database of the root node and propagating, by the root node, the changed state throughout the VSF stack topology.

### BACKGROUND

Multiple devices on a network, such as a router or switch, may be connected via a communication link, such as ethernet, to form a single virtual device, also known as a stack. If a break occurs in the communication link connecting the devices, a stack split may occur.

### BRIEF DESCRIPTION OF THE DRAWINGS

Some implementations of the present disclosure are described with respect to the following figures.

FIG. 1A is a block diagram of an example system for stateful virtual stack forwarding.

FIG. 1B is a block diagram of an example binary tree based on a VSF topology;

FIG. 1C is a block diagram of an example stack split.

FIG. 2 is a flow diagram of an example method for stateful virtual stack forwarding.

FIG. 3 is a block diagram of an example storage medium storing machine-readable instructions for stateful virtual stack forwarding.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

However, certain problems may arise when there are link failures or switch failures which cause a stack split. For example, a stack split may occur when there are multiple failures in a stack in a Ring configuration, when there is a single failure in a stack in a Chain configuration, when there is an error in both the commander and standby nodes, when the line card reboots, etc.

In the event of a stack split, a fragment may be created which does not include the standby and commander nodes, but only includes member nodes. In this case all the member nodes in this fragment may be rebooted and new stack election starts when the member nodes are back online. This may lead to multiple fragments, each having their own commander and standby. The network service may be then interrupted until one of the active fragments is disabled. For example, having multiple fragments may lead to a network loop that may need to be resolved.

In contrast, embodiments of stateful virtual stack forwarding discussed herein may address network service interruptions in the case of a stack split by storing state information for the entire network on each device. The embodiments discussed herein may, sync configuration as well as states of the processes/protocols to a local database on each device in the stack. However, syncing information from one device to another may be CPU intensive work, especially in an environment with a single threaded database and/or a large number of devices (32+) in the stack. Moreover, it may be important to ensure that each device on the network has the same state information, in order to accurately recover state in the case of a stack split.

To solve this problem, Embodiments of stateful virtual stack forwarding discussed herein may create a Binary-Tree based on the VSF stack topology. The root of the tree could be chosen based on configuration or dynamic detection. The local database at the root node of the Binary-Tree subscribes to local database of the commander node and the local database at every other switch subscribes to the database at its Parent switch in Binary-Tree. Processes/Protocols update the local database at the Commander node, rather than the local database of the member nodes. The root node gets updates from the commander node and propagates the updates through the binary tree. In this manner, each device in the stack will have the configuration for the stack as well as the same state information.

In at least one embodiment, the subject matter claimed below includes a method. The method may comprise changing a state at a first device in a virtual stack forwarding (VSF) stack topology, wherein each device in the VSF stack topology has a synchronized state in a corresponding local database storing state and configuration for the device and transmitting, from the first device, the changed state to a commander node of the VSF stack topology. The method may comprise committing, by the commander node, the changed state to a first local database of the commander node and transmitting, by the commander node, the changed state to a root node of the VSF stack topology. The method may include committing, by the root node, the changed state to a second local database of the root node and propagating, by the root node, the changed state throughout the VSF stack topology.

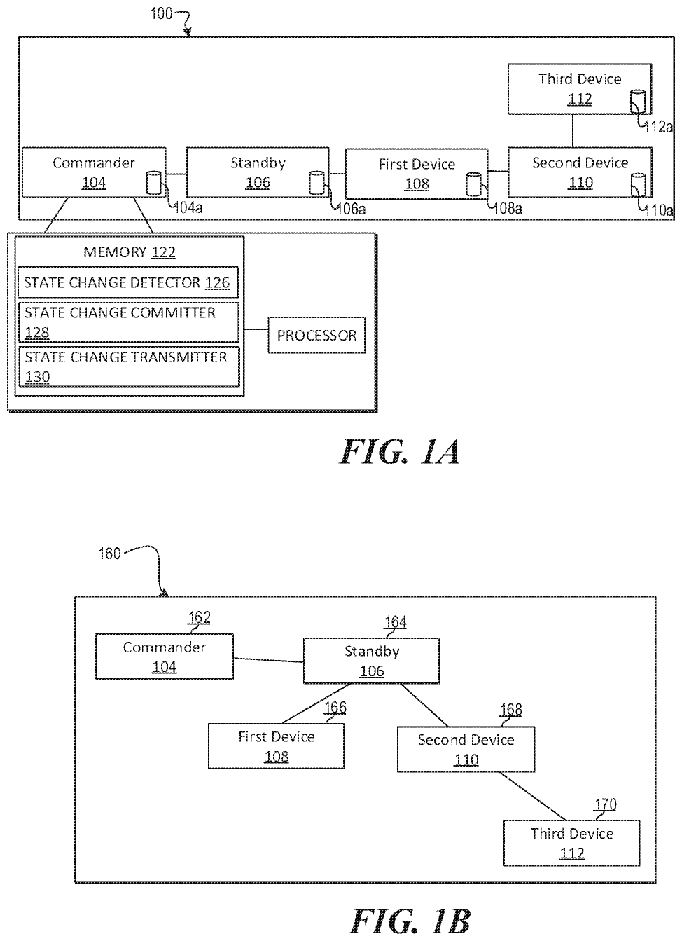

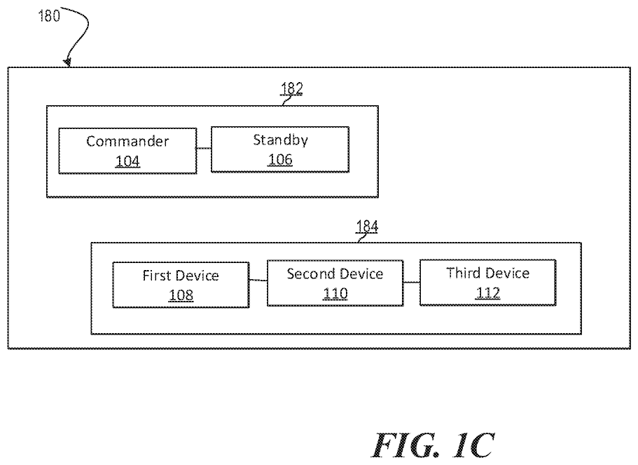

FIG. 1A is a block diagram of an example system for stateful virtual stack forwarding. A networking system 100, may include a plurality of network devices 104-112. The plurality of network devices 104-112 may be connected via a communication link to form a single virtual device, also known as a stack. The communication link may be a physical link, such as Ethernet, a wireless link, etc.

The network devices may, for example, be network switches with routing capabilities such that the network device is responsible for routing data along a route (or equivalently, path) in the network. The network device may perform, for example, routing of data based on routing information accessible by the router. For example, the routing information can be stored on a storage medium of the network device, or on a storage medium separate from but accessible by the network device.

Virtual Stack Forwarding (VSF) is one technology which enables multiple network devices to be connected via an Ethernet link to form a stack. The devices can be connected in, for example, a chain or a ring topology to form the VSF Stack. The VSF stack can span across multiple geographical locations, such as multiple buildings. A typical VSF solution may implement a Commander and Standby solution. In such an implementation, when the stack is initially formed, one network device in the stack will be selected as a commander node and another one will be selected as standby node. The other devices in the stack will act as member nodes. The commander node syncs the configuration of the stack to the standby node, so that in the event of failure of the commander node, the standby node can take over as the commander node with minimal interruption of service.

The system 100 includes an example VSF stack including a commander 104, a standby device 106, a first device 108, a second device 110 and a third device 112. Each of these network devices may have a corresponding local database, 104a-112a, respectively. The local database may be a centralized database, storing the state and configuration of the network switch as well as state and configuration of other devices of the network or of the network in general. Each device may subscribe to the local database of each other device in the stack, network, etc. to receive changes.

The network device may store some or all of the configuration, status, states and statistics of the network, and/or other devices on the network at any given point at time. The different state data may be accessed from the database either individually (data for a given time, a given device, etc.) or in aggregate (data aggregated for particular items over a given time period, etc.).

In some implementations, each device and its corresponding database form a centralized database architecture and operate according to a centralized database architecture protocol. One example of such a centralized database architecture protocol is an open vswitch database (OVSDB) architecture or protocol. In some implementations, the disclosed switches operate in accordance with an equal-cost multi-path (ECMP) routing protocol or strategy. Specifically, system 100 may implement a database-centric parallel processing model in which each daemon (i.e. application/process) uses the shared database for communicating between each other.

The binary tree may be created via a configuration interface, such as a CLI interface. The binary-tree may be dynamically created. For example, a unicast tree may be created at the time of stack formation. One or more of the network devices may be used to determine the root election and the tree may be formed based on the root selection. For example, each network device that is connected via a communication link (such as a physical connection, wireless connection, etc.) may become a child node of the root node. Each network device connected to each child node may become a child node of that device and so on.

An example binary tree 160 is presented in FIG. 1B. In the example binary tree 160 on FIG. 1B, the network device serving as the commander node 162 is the commander device 104. The standby device 106 serves as the root node 164 of the tree and the first device 108 and the second device 110 are child nodes 166 and 168, respectively, of the root node 164. Third device 112 is a child node 170 of the node 168. Of course, this is a simplified binary tree for explanatory purposes only and other binary-tree arrangements may be used with other numbers of network device. For example, some aspects, the commander node may also be the root node of the tree as well.

In the event of a configuration change, the following scenario may occur. For the sake of explanation, it will be assumed that the local database of each network device in the binary tree 160 is at time 0 (T0). A state change may occur at a network device, such as first device 106, at T1. First device 106 does not update its own local database 106a, but instead transmits the state change to the commander 104. The commander 104 commits the state change to its local database 104a. The local database 104a has a snapshot of the state data at T0, previous to the state change at T1. Accordingly, the commander 104 may determine a difference between the state of the local database 104a at T0 and the state of the local database at T1 after the state change. It may transmit the status change to the root node, in the form of this difference.

The commander 104 then transmits state change to the root node 164, of the binary tree, which in the example binary tree 160 is the standby device 106. The node 164 commits the configuration change to its local database 106a and then transmits the state change to the child nodes 166 (first device 108) and 168 (second device 110) of the standby node 164. First device 108 commits the state change to its local database 108a and second device 110 commits the state change to its local database 110a. Second device 110 transmits the state change to its child node 170, which is the third device 112. Then the third device 112 commits to the state change to its local database 112a.

Executing above mentioned process synchronizes the local database of each device, making the state of each of the network devices in sync. If the link between any of the two devices goes down, the state will still be available and the stack can be reformed. Turning to FIG. 1C a VSF stack split 180 is depicted. The stack split depicted in FIG. 1A consisting of the plurality of network devices 104-112 is split into two active fragments. The first active fragment 182 includes the commander 104, the standby device 106. The second active fragment 184 includes the first device 108, second device 110 and the third device 112. Even though the second active fragment 184 does not include either the commander or the standby, the first device, the second device and the third device have the current state of the stack stored on their local databases, respectively. A reboot of the devices in the second active fragment is not necessary in order to reform the stack and select a new commander and standby for the stack. Accordingly, there is no downtime. A New commander can be selected immediately after split and Multi Active Detection (MAD) will disable one of the active fragment. Now there is no need of warm reboot of member switches. In some aspects, each of the plurality of switches may also be connected to a network device operating a MAD service. A variety of MAD services may be used, such as a wired, wireless, etc.

An virtual device, such as a stack, may appear as a single node on the network. Accordingly, each of the network devices included in the stack may share the same IP address and/or Layer 3 configurations such as the routing configurations. When an link failure causes the stack to split, multiple active fragments that have the same IP address and/or Layer 3 configurations may appear on the network. They cause routing problems and data loss.

To detect and handle multi-active collisions, the MAD service may identifies each network device with an ID, which may be, for example, the member ID of the master. If multiple identical active fragments are detected, the MAD service may select one to operate. For example, the MAD service may select the fragment that has the lowest active ID. MAD sets all other IRF virtual devices in the recovery state, and shuts down all their physical ports except the console and IRF ports. Of course, these are only examples, and the MAD service may use other criteria and take other actions when resolving stack splits.

Turning again to FIG. 1A, system 100 may include a processor 120 and a memory 122 that may be coupled to each other through a communication link (e.g., a bus). Processor 120 may include a single or multiple Central Processing Units (CPU) or another suitable hardware processor(s). In some examples, memory 122 stores machine readable instructions executed by processor 120 for system 100. Memory 122 may include any suitable combination of volatile and/or non-volatile memory, such as combinations of Random Access Memory (RAM), Read-Only Memory (ROM), flash memory, and/or other suitable memory.

Memory 122 stores instructions to be executed by processor 120 including instructions for state change detector 126, state change committer 128, state change transmitter 130, and/or other components. According to various implementations, system 100 may be implemented in hardware and/or a combination of hardware and programming that configures hardware. Furthermore, in FIG. 1 and other Figures described herein, different numbers of components or entities than depicted may be used. Although the processor 120 and memory 122 are depicted in FIG. 1A as part of commander 104, this is for example purposes only and each of the plurality of network devices 104-112 may have a similar processor and memory and execute instructions similar to those discussed in FIGS. 1A-3.

Processor 120 may execute state change detector 126 to detect, by a commander node, a state change in a first device in a virtual stack forwarding (VSF) stack topology. Each device in the VSF stack topology may have a synchronized state in a corresponding local database storing state and configuration for the device.

Processor 120 may execute state change committer 128 to commit, by the commander node, the changed state to a first local database of the commander node. A device other than the commander node of the VSF stack topology may be the root node of the binary tree.

Processor 120 may execute state change transmitter to transmit, by the commander node, the changed state to a root node of the VSF stack topology. The root node is to commit the changed state to a second local database of the root node and propagate the changed state throughout the VSF stack topology. In some aspects, the VSF stack topology is arranged as a binary tree and propagating the changed state through the VSF stack topology comprises transmitting the changed state to each child node of the root node, committing the changed state to a local database of each child node, transmitting changed state to a subsequent child node and committing to a local database of each subsequent child node. The first device does may commit the state change to a first device local database before transmitting the changed state to the commander node. Instead, the first device may commit the state change to the first device local database after receiving the state change via the propagation throughout the VSF stack topology originated by the root node.

In some aspects, processor 120 may execute a stack detector to detect that a VSF stack has been split into multiple active fragments and the first multiple active fragment may not include both the commander node and the standby node.

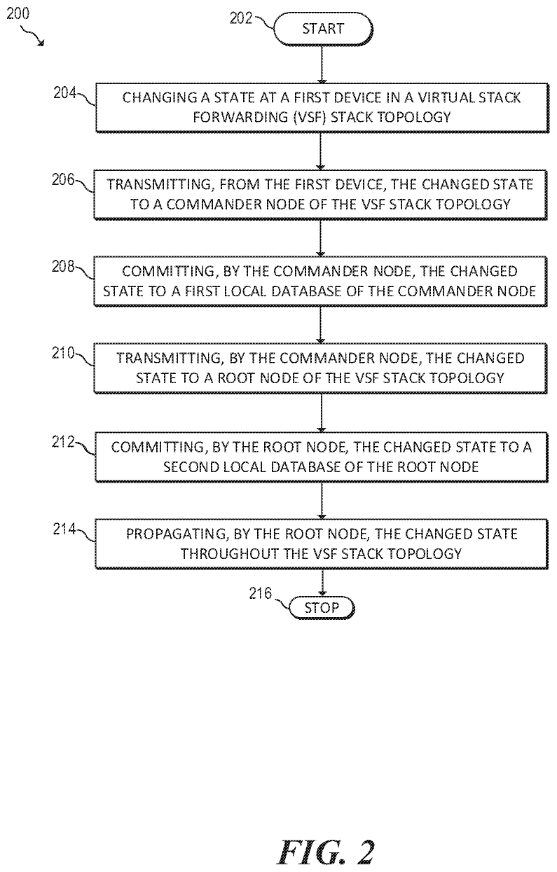

FIG. 2 is a flow diagram of an example method for stateful virtual stack forwarding. The method may begin at block 202 and proceed to block 204 where the method may include changing a state at a first device in a virtual stack forwarding (VSF) stack topology. Each device in the VSF stack topology may have a synchronized state in a corresponding local database storing state and configuration for the device. At block 206, the method may include transmitting, from the first device, the changed state to a commander node of the VSF stack topology and block 208 committing, by the commander node, the changed state to a first local database of the commander node.

The method may include determining, by the first device, to not commit the state change to a first device local database before transmitting the changed state to the commander node.

The method may also include determining, by the first device, to not commit the state change to a first device local database before transmitting the changed state to the commander node and committing, by the first device, the state change to the first device local database after receiving the state change via the propagation throughout the VSF stack topology originated by the root node. In some aspects the first device is the root node, and the method may include determining, by the first device, to not commit the state change to a first device local database before transmitting the changed state to the commander node and committing, by the first device, the state change to the first device local database after receiving the state change from the commander node.

At block 210, the method may include transmitting, by the commander node, the changed state to a root node of the VSF stack topology. A device other than the commander node of the VSF stack topology may be the root node of the binary tree. At block 212, the method may include committing, by the root node, the changed state to a second local database of the root node and at block 214, the method may include propagating, by the root node, the changed state throughout the VSF stack topology.

The VSF stack topology may be arranged as a binary tree and propagating the changed state through the VSF stack topology may include transmitting, by the root node, the changed state to each child node of the root node, committing, by each child node, the changed state to a local database of each child node, transmitting, by the child node, the changed state to a subsequent child node and committing, by the subsequent child node, to a local database of each subsequent child node.

The method may also include detecting, at a second device, that a VSF stack has been split into multiple active fragments, wherein the second device is not one of the commander node or a standby node of the VSF stack and a first multiple active fragment includes the second device and does not include both the commander node and the standby node and selecting, by one of the devices in the first multiple active fragment, a new commander node and a new standby node.

The method may proceed to block 216, where the method may end.

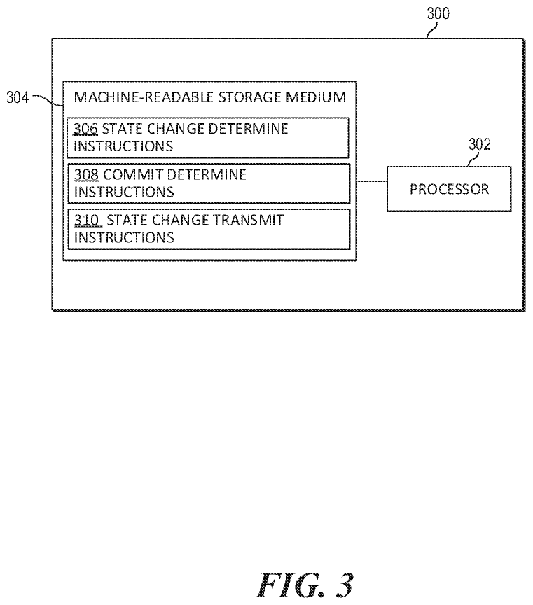

FIG. 3 is a block diagram of an example storage medium storing machine-readable instructions for stateful virtual stack forwarding. In the example illustrated in FIG. 3, system 300 includes a processor 302 and a machine-readable storage medium 304. In some aspects, processor 302 and machine-readable storage medium 304 may be part of an Application-specific integrated circuit (ASIC). Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 302 may be at least one central processing unit (CPU), microprocessor, and/or other hardware devices suitable for retrieval and execution of instructions stored in machine-readable storage medium 304. In the example illustrated in FIG. 3, processor 302 may fetch, decode, and execute instructions 306, 308 and 310. Processor 302 may include at least one electronic circuit comprising a number of electronic components for performing the functionality of at least one of the instructions in machine-readable storage medium 304. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 304 may be any electronic, magnetic, optical, or other physical storage device that stores executable instructions. Thus, machine-readable storage medium 304 may be, for example, Random Access Memory (RAM), an Electrically-Erasable Programmable Read-Only Memory (EEPROM), a storage drive, an optical disc, and the like. Machine-readable storage medium 404 may be disposed within system 300, as shown in FIG. 3. In this situation, the executable instructions may be “installed” on the system 300. Machine-readable storage medium 304 may be a portable, external or remote storage medium, for example, that allows system 300 to download the instructions from the portable/external/remote storage medium. In this situation, the executable instructions may be part of an “installation package”. As described herein, machine-readable storage medium 304 may be encoded with executable instructions for context aware data backup. The machine-readable storage medium may be non-transitory.

Referring to FIG. 3, state change determine instructions 306, when executed by a processor (e.g., 302), may cause system 300 to detect a state change by a first device in a virtual stack forwarding (VSF) stack topology, wherein each device in the VSF stack topology has a synchronized state in a corresponding local database storing state and configuration for the device.

In some aspects, the machine-readable storage medium 304 may also include instructions that when executed by a processor (e.g., 302), may cause system 300 to determine, by the first device, to not commit the state change to a first device local database before transmitting the changed state to the commander node and commit, by the first device, the state change to the first device local database after receiving the state change via the propagation throughout the VSF stack topology.

In the some aspects, first device is a root node of the binary tree. In these aspects, the machine-readable storage medium 304 may also include instructions that when executed by a processor (e.g., 302), may cause system 300 to determine, by the first device, to not commit the state change to a first device local database before transmitting the changed state to the commander node and commit, by the first device, the state change to the first device local database after receiving the state change from the commander node.

Commit determine instructions 308, when executed by a processor (e.g., 302), may cause system 300 to determine, by the first device, to not commit the state change to a first local database before transmitting the changed state to the commander node.

State change transmit instructions 306, when executed by a processor (e.g., 302), may cause system 300 to transmit, by the first device, the changed state to the commander node of the VSF stack topology, wherein the commander node is to commit the changed state to a second local database of the commander node for propagation throughout the VSF stack topology.

In some aspects, the VSF stack topology is arranged as a binary tree and the commander node is a root node of the binary tree. Propagating the changed state through the VSF stack topology may include transmitting the changed state to each child node of the root node, committing the changed state to a local database of each child node, transmitting the changed state to a subsequent child node and committing to a local database of each subsequent child node.

In some aspects, the machine-readable storage medium 304 may also include instructions that when executed by a processor (e.g., 302), may cause system 300 to detect, at the first device, that a VSF stack has been split into multiple active fragments, wherein the first device is not one of the commander node or a standby node of the VSF stack and a first multiple active fragment includes the second device and does not include both the commander node and the standby node and select, by the first device, a new commander node and a new standby node.

The foregoing disclosure describes a number of examples for stateful virtual stack forwarding. The disclosed examples may include systems, devices, computer-readable storage media, and methods for stateful virtual stack forwarding. For purposes of explanation, certain examples are described with reference to the components illustrated in FIGS. 1A-3. The content type of the illustrated components may overlap, however, and may be present in a fewer or greater number of elements and components. Further, all or part of the content type of illustrated elements may co-exist or be distributed among several geographically dispersed locations. Further, the disclosed examples may be implemented in various environments and are not limited to the illustrated examples.

Further, the sequence of operations described in connection with FIGS. 1A-3 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1. A method comprising:
changing a state at a first device in a virtual stack forwarding (VSF) stack topology, wherein each device in the VSF stack topology has a synchronized state in a corresponding local database storing state and configuration for the device;
transmitting, from the first device, the changed state to a commander node of the VSF stack topology;
committing, by the commander node, the changed state to a first local database of the commander node;
transmitting, by the commander node, the changed state to a root node of the VSF stack topology;
committing, by the root node, the changed state to a second local database of the root node; and
propagating, by the root node, the changed state throughout the VSF stack topology.

2. The method of claim 1, comprising:
detecting, at a second device, that a VSF stack has been split into multiple active fragments, wherein the second device is not one of the commander node or a standby node of the VSF stack and a first multiple active fragment includes the second device and does not include both the commander node and the standby node.

3. The method of claim 2, comprising:
selecting, by one of the devices in the first multiple active fragment, a new commander node and a new standby node.

4. The method of claim 1, wherein the VSF stack topology is arranged as a binary tree and propagating the changed state through the VSF stack topology comprises
transmitting, by the root node, the changed state to each child node of the root node;
committing, by each child node, the changed state to a local database of each child node;
transmitting, by the child node, the changed state to a subsequent child node; and
committing, by the subsequent child node, to a local database of each subsequent child node.

5. The method of claim 4, wherein a device other than the commander node of the VSF stack topology is the root node of the binary tree.

6. The method of claim 1, comprising:
determining, by the first device, to not commit the state change to a first device local database before transmitting the changed state to the commander node; and
committing, by the first device, the state change to the first device local database after receiving the state change via the propagation throughout the VSF stack topology originated by the root node.

7. The method of claim 1 wherein the first device is the root node, the method comprising:
determining, by the first device, to not commit the state change to a first device local database before transmitting the changed state to the commander node; and
committing, by the first device, the state change to the first device local database after receiving the state change from the commander node.

8. A system comprising:
a state change detector to detect, by a commander node, a state change in a first device in a virtual stack forwarding (VSF) stack topology, wherein each device in the VSF stack topology has a synchronized state in a corresponding local database storing state and configuration for the device;
a state change committer to commit, by the commander node, the changed state to a first local database of the commander node; and
a state change transmitter to transmit, by the commander node, the changed state to a root node of the VSF stack topology, wherein the root node is to commit the changed state to a second local database of the root node and propagate the changed state throughout the VSF stack topology.

9. The system of claim 8, comprising:
a stack detector to detect that a VSF stack has been split into multiple active fragments, wherein a first multiple active fragment does not include both the commander node and the standby node.

10. The system of claim 8, wherein the VSF stack topology is arranged as a binary tree and propagating the changed state through the VSF stack topology comprises:
transmitting the changed state to each child node of the root node;
committing the changed state to a local database of each child node;
transmitting changed state to a subsequent child node; and
committing to a local database of each subsequent child node.

11. The system of claim 8, wherein a device other than the commander node of the VSF stack topology is the root node of the binary tree.

12. The system of claim 8, wherein the first device does not commit the state change to a first device local database before transmitting the changed state to the commander node.

13. The system of claim 8, wherein the first device is to commit the state change to the first device local database after receiving the state change via the propagation throughout the VSF stack topology originated by the root node.

14. A non-transitory computer-readable storage medium encoded with instructions, the instructions executable by a processor of a system to cause the system to:
detect a state change by a first device in a virtual stack forwarding (VSF) stack topology, wherein each device in the VSF stack topology has a synchronized state in a corresponding local database storing state and configuration for the device;
determine, by the first device, to not commit the state change to a first local database before transmitting the changed state to the commander node; and
transmit, by the first device, the changed state to the commander node of the VSF stack topology, wherein the commander node is to commit the changed state to a second local database of the commander node for propagation throughout the VSF stack topology.

15. The non-transitory computer-readable storage medium of claim 14, the instructions executable by a processor of a system to cause the system to:
detect, at the first device, that a VSF stack has been split into multiple active fragments, wherein the first device is not one of the commander node or a standby node of the VSF stack and a first multiple active fragment includes the second device and does not include both the commander node and the standby node.

16. The non-transitory computer-readable storage medium of claim 15, the instructions executable by a processor of a system to cause the system to:
select, by the first device, a new commander node and a new standby node.

17. The non-transitory computer-readable storage medium of claim 14, wherein the commander node is a root node of the binary tree.

18. The non-transitory computer-readable storage medium of claim 17, wherein the VSF stack topology is arranged as a binary tree and the instructions executable by a processor of a system to propagate the changed state through the VSF stack topology cause the system to:
transmit the changed state to each child node of the root node;
commit the changed state to a local database of each child node;
transmitting the changed state to a subsequent child node; and
committing to a local database of each subsequent child node.

19. The non-transitory computer-readable storage medium of claim 17, wherein the first device is a root node of the binary tree, the instructions executable by a processor of a system to cause the system to:
determine, by the first device, to not commit the state change to a first device local database before transmitting the changed state to the commander node; and
commit, by the first device, the state change to the first device local database after receiving the state change from the commander node.

20. The non-transitory computer-readable storage medium of claim 14, the instructions executable by a processor of a system to cause the system to:
determine, by the first device, to not commit the state change to a first device local database before transmitting the changed state to the commander node; and
commit, by the first device, the state change to the first device local database after receiving the state change via the propagation throughout the VSF stack topology.
